(19) United States
(12) Patent Application Publication
(10) Pub. No.: US 2014/0189412 A1
(43) Pub. Date: Jul. 3, 2014

(54) TIME SEQUENCE CIRCUIT FOR POWER SUPPLY UNIT

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/142,916

(22) Filed: Dec. 29, 2013

(30) Foreign Application Priority Data
Dec. 29, 2012 (CN) 2012105885765

(51) Int. Cl. G06F 1/26

(52) U.S. Cl. CPC G06F 1/263
USPC 713/330

(57) ABSTRACT

A time sequencing circuit for a power supply unit to ensure the correct sequencing of system voltages for a computer from a power supply unit includes first to fifth resistors, an electronic switch, first to third comparators, and a capacitor. Each of the first to third comparators includes an inverting input terminal, a non-inverting input terminal, and an output terminal When the power supply unit outputs all required voltages, the power supply unit outputs a high-voltage level indicating power good and the computer can start up power good signal. If one of the voltages is not outputted, the power supply unit outputs a low-voltage level good signal until any non-output of voltage is cured.

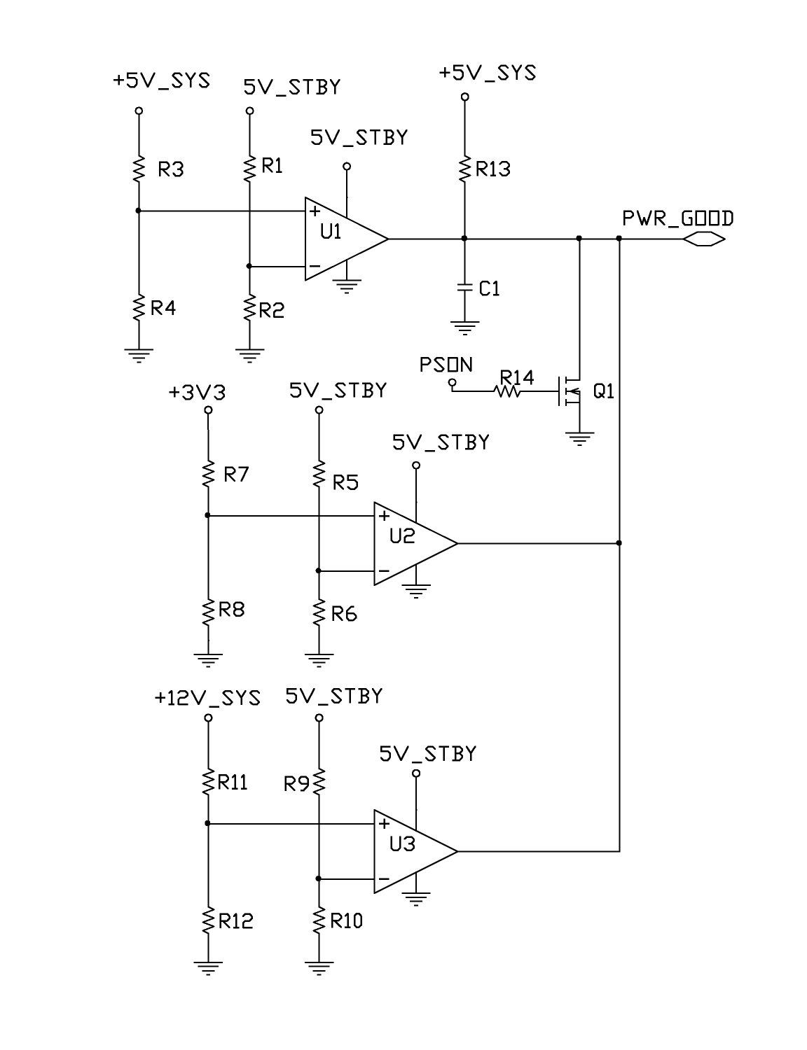

### BACKGROUND

1. Technical Field

The present disclosure relates to a time sequence circuit for a power supply unit.

2. Description of Related Art

During a power-on operation of a computer, a motherboard of the computer may change a power-on signal PS_ON from a high-voltage level to a low-voltage level. When a power supply unit receives the low-voltage level power-on signal PS_ON, the power supply unit simultaneously outputs different voltages, such as 3V3, +5V_SYS, 5V_STBY, and +12V_SYS voltages. When all the different voltages are being outputted, the power supply unit further outputs a high-voltage level power good signal after 100-500 milliseconds, and then the computer can start up. However, a user may use different types of power supply units, of which the time sequencing of the voltages from the power supply unit may be unsuitable for the motherboard.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure.

The FIGURE is a circuit diagram of an embodiment of a time sequence circuit for a power supply unit.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The FIGURE illustrates an embodiment of a time sequence circuit for a power supply unit. The time sequence circuit comprises fourteen resistors R1-R14, a metal oxide semiconductor field effect transistor (MOSFET) Q1, three comparators U1-U3, and a capacitor C1.

An inverting input terminal of the comparator U1 is coupled to a stand-by power terminal 5V_STBY through the resistor R1, and is connected to ground through the resistor R2. A non-inverting input terminal of the comparator U1 is coupled to a system power terminal +5V_SYS through the resistor R3, and is also connected to ground through the resistor R4. A power terminal of the comparator U1 is coupled to the stand-by power terminal 5V_STBY, and a ground terminal of the comparator U1 is connected to ground. An output terminal of the comparator U1 is coupled to the system power terminal +5V_SYS through the resistor R13, and is connected to ground through the capacitor C1. The output terminal of the comparator U1 outputs a power good signal.

An inverting input terminal of the comparator U2 is coupled to the stand-by power terminal 5V_STBY through the resistor R5, and is connected to ground through the resistor R6. A non-inverting input terminal of the comparator U2 is coupled to a system power terminal +3V3 through the resistor R7, and is also connected to ground through the resistor R8. A power terminal of the comparator U2 is coupled to the stand-by power terminal 5V_STBY, and a ground terminal of the comparator U2 is connected to ground. An output terminal of the comparator U2 is coupled to the output terminal of the comparator U1.

An inverting input terminal of the comparator U3 is coupled to the stand-by power terminal 5V_STBY through the resistor R9, and is connected to ground through the resistor R10. A non-inverting input terminal of the comparator U3 is coupled to a system power terminal +12V_SYS through the resistor R11, and is also connected to ground through the resistor R12. A power terminal of the comparator U3 is coupled to the stand-by power terminal 5V_STBY, and a ground terminal of the comparator U3 is connected to ground. An output terminal of the comparator U3 is coupled to the output terminal of the comparator U1.

A gate of the MOSFET Q1 receives a power on signal through the resistor R14, a source of the MOSFET Q1 is connected to ground, and a drain of the MOSFET Q1 is coupled to the output terminal of the comparator U1.

By setting resistance values of the resistors R1-R12, when the system power terminals for +3V3, +5V_SYS, +12V_SYS, and the 5V_STBY output corresponding voltages, voltages of the non-inverting input terminals of the comparators U1, U2, and U3 are respectively greater than voltages of the inverting input terminal. Accordingly, the output terminals of the comparators U1, U2, and U3 are at high-voltage level, such as logic 1.

During a power-on operation, if one of the system power terminals +3V3, +5V_SYS, and +12V SYS does not output a system voltage, one of the comparators U1, U2, or U3 outputs a low-voltage level, such as logic 0. For example, if the system power terminal +3V3 does not output the system voltage signal, the output terminal of the comparator U2 outputs the low-voltage level signal. During the power on operation, the power on signal PS_ON is at a low-voltage level, such as logic 0, the MOSFET Q1 turned off, and the output terminal of the comparator U1 is at a low-voltage level. Accordingly, the comparator Q1 outputs a low-voltage level power good signal.

During the power-on operation, when the system power terminals +3V3, +5V_SYS, and +12V_SYS all output their proper system voltages, the output terminals of the comparators Q1, Q2, and Q3 are at high-voltage level, and the MOSFET Q1 is turned on. Accordingly, the output terminals of the comparators U1, U2, and U3 charge the capacitor C1 for a predefined time duration. When the capacitor C1 is fully charged, the output terminal of the comparator U1 then outputs the high-voltage level power good signal.

When in a stand-by state, the power on signal PS_ON is at the high-voltage level. Thus, the MOSFET Q1 is turned on, making the output terminal of the comparator U1 output a low-voltage level power good signal.

In the embodiment, the MOSFET Q1 is an n-channel MOSFET. In other embodiments, the transistor can be replaced by another electronic switch, such as a bipolar junction transistor.

While the disclosure has been described by way of embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A time sequence circuit, comprising:
A first to fifth resistor;
an electronic switch comprising a first terminal, a second terminal, and a third terminal;
a capacitor; and
a first to third comparator each comprising an inverting input terminal, a non-inverting input terminal, a power terminal, a ground terminal, and an output terminal;
wherein the inverting input terminal of the first comparator is coupled to a first power terminal through the first resistor, and is connected to ground through the second resistor, the non-inverting input terminal of the first comparator is coupled to a second power terminal, the power terminal of the first comparator is coupled to the first power terminal, the ground terminal of the first comparator is connected to ground, and the output terminal of the first comparator is coupled to the second power terminal through the third resistor, and is connected to ground through the capacitor; the inverting input terminal of the second comparator is coupled to the first power terminal through the fourth resistor, and is connected to ground through the fifth resistor, the non-inverting input terminal of the second comparator is coupled to a third power terminal, the power terminal of the second comparator is coupled to the first power terminal, the ground terminal of the second comparator is connected to ground, and the output terminal of the second comparator is coupled to the output terminal of the first comparator; the inverting input terminal of the third comparator is coupled to the first power terminal, the non-inverting input terminal of the third comparator is coupled to a fourth power terminal, the power terminal of the third comparator is coupled to the first power terminal, the ground terminal of the third comparator is connected to ground, and the output terminal of the third comparator is coupled to the output terminal of the first comparator; the first terminal of the electronic switch is used to receive a power on signal, the second terminal of the electronic switch is connected to ground, the third terminal of the electronic switch is coupled to the output terminal of the first comparator, and the output terminal of the first comparator outputs a power good signal; when the first terminal of the first electronic switch is at a low-voltage level, the second and third terminals of the electronic switch are disconnected from each other; when the first terminal of the first electronic switch is at a high-voltage level, the second and third terminals of the electronic switch are connected to each other.

2. The time sequence circuit of claim 1, further comprising a sixth to ninth resistor, wherein the non-inverting terminal of the first comparator is coupled to the second power terminal through the sixth resistor, and is connected to ground through the seventh resistor; the non-inverting terminal of the second comparator is coupled to the third power terminal through the eighth resistor, and is connected to ground through the ninth resistor.

3. The time sequence circuit of claim 2, further comprising a tenth to thirteenth resistor, wherein the inverting terminal of the third comparator is coupled to the first power terminal through the tenth resistor, and is connected to ground through the eleventh resistor; the non-inverting terminal of the third comparator is coupled to the fourth power terminal through the twelfth resistor, and is connected to ground through the thirteenth resistor.

4. The time sequence circuit of claim 3, further comprising a fourteenth resistor, wherein the first terminal of the electronic switch receives the power on signal through the fourteenth resistor.

5. The time sequence circuit of claim 4, wherein the electronic switches is an n-channel metal oxide semiconductor field effect transistor (NMOSFET), and the first terminal, second terminal, and the third terminal of the electronic switch is a gate, a source, and a drain of the NMOSFET, respectively.
